(19) United States
(12) Patent Application Publication
(10) Pub. No.: US 2003/0108654 A1
(43) Pub. Date: Jun. 12, 2003

(54) Low-carbohydrate potato products and process

(76) Inventor: Randall S. Blaun, New York, NY (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/317,530

(22) Filed: Dec. 12, 2002

Related U.S. Application Data
(60) Provisional application No. 60/380,984, filed on May 15, 2002.
(60) Provisional application No. 60/339,618, filed on Dec. 12, 2001.

(51) Int. Cl. A23L 1/216

(52) U.S. Cl. 426/637

(57) ABSTRACT

Low-carbohydrate potato products include potato and cauliflower. Preferably, they are mixed together dry with a suitable water-dispersible or water-soluble binder. The dry mix can be prepared by mixing dried potato and dried cauliflower. A preferred form of the mix can be prepared for serving by mixing with water to provide a suitable consistency for final preparation, e.g., by simply heating or frying or baking. Potato products, especially those prepared from the dry mix and the above process are also described. Products that do not require shelf-stable storage do not require dry ingredients for their preparation and can be made from the indicated ingredients without drying by simply mixing the ingredients, e.g., potatoes and cauliflower, in their natural or cooked state.

### BACKGROUND OF THE INVENTION

The invention relates to potato products of modified formulation, which are especially suitable for people restrained to or desiring low-carbohydrate diets.

Nutrition and dietary factors play important roles in health promotion and chronic disease prevention. See, for example: 1) McGinnis J M, Foege W H. Actual causes of death in the United States. JAMA. 1993;270:2207-2212; 2) Committee on Diet and Health, Food and Nutrition Board, Commission on Life Sciences, National Research Council. Diet and Health: Implications for Reducing Chronic Disease Risk. Washington, D.C.: National Academy Press; 1989; and 3) The Surgeon General's Report on Nutrition and Health. Washington, D.C.: US Dept of Health and Human Services; 1988 and DHHS (PHS) publication No. 88-50210. The Surgeon General's report states, “For two out of three adult Americans who do not smoke and do not drink excessively, one personal choice seems to influence long-term health prospects more than any other: what we eat.” (p 1).

People process foods differently and are faced with choices for health and self-image. Low-carbohydrate diets are available for many people who either cannot or choose not to consume large amounts of foods containing refined carbohydrates, such as sugars and carbohydrates. These diets are premised on the principal that excess carbohydrates are important factors for many for creating and storing large amounts of body fat.

Low-carbohydrate diets differ from those advocated by many traditional nutrition authorities who favor diets based on the so-called “food pyramid”, whose foundation rests on consumption of large amounts of high carbohydrate foods. The food pyramid lists foods without accounting for a need for restriction on carbohydrate intake. Thus, all fruits and vegetables and grains figure prominently in that view of a healthy diet. Low-carbohydrate diets, on the other hand, typically prohibit or severely limit all foods containing starches and sugars, including all grains, cereals, potatoes, and foods made with them. Allowed foods for a low-carbohydrate weight loss diet include meats, poultry, fish, shellfish, fats/oils, some dairy products (heavy cream, butter, and some cheeses), all green and other non-starchy vegetables, and a few other relatively low carbohydrate fruits.

Various people advocate certain variations to these criteria. For example, in U.S. Pat. No. 5,855,949, McLean advocates a low-carbohydrate, moderate-protein diet. He indicates that the patient should exclude all high starch products including cereals, breads, pastas (all flour products), rice, peas, corn, and potatoes. These products are said to have a high glycemic index, which stimulates the insulin-driven pathway. He also recommends excluding certain foods that he indicates are likely to counteract the effects of the dietary system of the his diet. Among others, he names soy and soy products, turnips, broccoli, cauliflower, Brussels sprouts, peanuts, and cabbage. These, he says have been shown to exhibit antithyroid activity in the body and are known to support the development of a hypothyroid system and resulting goiter. Typically, low-carbohydrate diets focus on reducing carbohydrates and do not stress calorie restriction.

There are also very significant differences between “low-fat” and “low-carbohydrate” diets. A diet simply restricting calories can reduce the intake of protein and fat and burns large amounts of both fat and muscle to provide fuel. These diets help an individual to lose weight, but may result in loss of muscle and reduction in basal metabolic rate. The result can be an increased need to cut calories.

On an effective low-carbohydrate diet, the body burns mostly fat and preserves lean muscle tissue. Exercise can add muscle while losing fat, thereby increasing a subject's basal metabolic rate, and enhancing the loss of fat. According to some studies, carbohydrates act very much like an addictive drug for some people. The more they eat, the more they crave those foods. On a low-carbohydrate diet, once past the initial few days, those cravings can significantly diminish, or disappear completely.

There is a need for low-carbohydrate foods of greater variety than naturally occur to enable those on low-carbohydrate diets to eat many of the foods they are accustomed to but on the restricted or prohibited list. Among the needed new foods are low-carbohydrate potato products because people like potatoes, but they are essentially employed in conventional diets as a rich source of carbohydrates. To date, however, there are no known suitable low-carbohydrate potato products, dry mixes for their preparation or processes suitable to the task.

### DISCLOSURE OF INVENTION

Accordingly, it is an object of the invention to provide a low-carbohydrate potato product.

It is another object of the invention to provide a process for preparing a low-carbohydrate potato product.

It is another object of the invention to provide dry mix for preparing a low-carbohydrate potato product.

These and other objects are realized by the present invention, which provides a low-carbohydrate potato product and a dry mix and process for preparing it.

One aspect of the invention comprises a dry mix for preparing a low-carbohydrate potato product, comprising: dried potato and dried cauliflower, preferably mixed together with a suitable water-dispersible or water-soluble binder. A preferred form of the mix can be prepared by mixing with water to provide a suitable consistency for final preparation, e.g., by simply heating or frying or baking.

In another aspect, the invention provides a process for preparing a low-carbohydrate potato product, comprising: mixing dried potato and dried cauliflower, together with a suitable water-dispersible or water-soluble binder, with an aqueous liquid in an amount sufficient to fully hydrate the dried potato, cauliflower and any binder or water-soluble ingredients to provide a suitable consistency for final preparation; and finally preparing the resulting mixture, e.g., by cooking.

Potato products, especially those prepared from the dry mix and the above process are also described. Products that do not require shelf-stable storage do not require dry ingredients for their preparation and can be made from the indicated ingredients without drying by simply mixing the ingredients, e.g., potatoes, in their natural or cooked state.

Other preferred aspects of the invention will be detailed below.

### DETAILED DESCRIPTION OF THE INVENTION

The invention will be described below with specific reference to preferred formulations and preferred processing techniques; however, it will be clear to the experienced food scientist that the principles that enable improvements in these will apply to other products as well, including frozen prepared products.

By the term “low-carbohydrate” is meant an amount of a food in a 100 gram serving which supplies less than about one fourth of the daily recommended intake of carbohydrate for a low-carbohydrate diet. Generally, a “low-carbohydrate diet” is defined as any diet that includes less than 100 grams of carbohydrate for an average person per day. Thus, all of the products of the invention will have carbohydrate in minor amounts, preferably in an amount of no more than 25 grams per serving. Preferably, the carbohydrate content is less than 15 grams per serving, e.g., 5 to 10 grams per serving.

The term “potato” is meant to include all of those starchy tubers typically identified as potatoes, including by way of example, Idaho, russet, sweet, yam, and the like. The potato can be supplied in dried or wet form initially and then finally dried, if desired, for packaging. In the case of dried potatoes, they can be prepared by any suitable process, such as drum drying, spray drying, freeze drying, and the like. The potato ingredient of the invention will preferably be present at a level of from about 10 to about 50% by weight of dry solids in preferred formulations. This basis, i.e., weight of dry solids will be that used throughout the description, unless otherwise indicated. For food products containing other identifiable components, like hash which has a meat component, these and the following percentages will be based on the potato portion of the food.

The term “potato product” is meant to include all foods containing sufficient potato solids to provide a flavor identifiable as “potato” or “potato like” by a panel of expert tasters. An expert taster is a person trained to taste and objectively evaluate specific food flavors. The criteria for each evaluation are established and the sample size is selected to obtain determination of “potato” or “potato like” with a degree of confidence of at least 95%. It is an advantage that the products of the invention have a mealy, potato-like texture in addition to a potato flavor. This result is achieved by replacing a portion of the potato with lower carbohydrate, non-starchy foods, particularly cauliflower, in amounts effective to achieve a desired reduction in carbohydrate content while retaining potato flavor and texture in preferred formulations.

The term “cauliflower” is defined to mean a cauliflower component, which preferably contains cauliflower in principal proportion of this component, but can be supplemented with other like foods, including turnip, rutabaga and the like. The use of such materials can provide a suitable texture and flavor when properly compounded. The cauliflower will be used at level of from about 20 to about 50%. More typical ranges will be from about 25 to about 40% by weight. The cauliflower can be employed in some embodiments at a weight ratio to the potato of from about 1:3 to about 3:1. Preferred ratios tend to be within the narrower range of from about 2:3 to about 3:2.

The products of the invention will also include one or more non-carbohydrate binder/filler components, preferably selected from the group consisting of: protein concentrates, protein salts, powdered cellulose, and the like. Cellulose and other such binder/filler components can have limited digestibility or be wholly non-digestible. Non-carbohydrate binder/filler components will preferably comprise from about 10 to about 60% by weight in preferred formulations. The binder/filler component can comprise one or more protein concentrates, such as those selected from the group consisting of calcium caseinate, egg whites, whey protein concentrate or isolate, soy protein concentrate or isolate, as well as pea, bean or other vegetable-protein isolates, and the like. In some preferred embodiments, a combination of calcium caseinate and dried egg whites can be employed with the calcium caseinate being employed at a level within the range of from 10 to 40% by weight and the dried egg whites at a level of from about 6 to 30% by weight. The binder/filler component can be employed in some embodiments at a weight ratio to the potato of from about 1:2 to about 5:1. Preferred ratios tend to be within the narrower range of from about 2:3 to about 3:1. And, ratios of calcium caseinate to other binder/filler components can be within these same relative ranges. Indigestible fillers such as powdered cellulose can be employed at levels up to about 10% by weight, e.g., 1 to 5%.

In addition to the above ingredients, the low-carbohydrate foods and mixes of the invention can comprise a flavoring component comprising spices. Preferred among the various flavoring components are those which are available in dry form. Some of those preferred are onion, black pepper, celery, cinnamon, clove, cumin, egg yolk, garlic, milk, mustard, nutmeg, oregano, paprika, parsley, tomato, turmeric, and mixtures of at least two of these. Any other spices and vegetable products available in dry form can also be employed as long as they don't unduly increase the hygroscopicity of the composition. For example, in addition to black pepper, there are white pepper, various dried bell peppers, hot peppers of a number of varieties, and the like. Also various other spices can be employed as desired for taste. It is important that the various flavorings be capable of dry blending, so granular or particulate forms are desired. However, some materials are important also for their mouthfeel when hydrated or their visual impact and these factors will be taken into account for them. Salt is also preferred at suitable levels for good taste, e.g., up to about 2%, but can be reduced as desired. Salt substitutes can also be employed at suitable levels.

The compositions of the invention can also include suitable thickening agents, which will preferably be one or a combination which is easily hydratable and provides the mouthfeel desired for the final food product. Preferably, the thickening agent will comprise, in dry form, a member selected from the group consisting of flour, starch, vegetable gums and hydrocolloids, including xanthan gum, alginates, gelatin, pectin, and mixtures of at least two of these and substitutes or equivalents. The examples, which follow, will provide the skilled worker with guidelines as to materials and amounts.

The process of the invention entails mixing the ingredients in a manner that provides a uniform blend having the desirable textural properties. The process is exemplified below. In one aspect, the process for preparing a low-carbohydrate potato product utilizing the mix comprises: hydrating the mix; extruding the hydrated mix; cutting the extruded mix into strips of suitable size for frying as French fries. Square or other cross sections are possible, including triangular, circular, rounded, rectangular, or the like. Dimensions across the length will typically be in the range of from 0.10 to 1.0 inch and lengths of from 0.5 to 12 inches. More typically from 0.15 to 0.40 inch across and 1 to 6 inches in length. The product is cooked in a suitable manner, such as by frying, particularly, deep fat frying.

Typical of extruders are single screw extruders of the Braebender type, such as are widely used in the food industry, and double screw devices. Also, complex extruders can be effective.

Potato products, especially those prepared from the dry mix and the above process are also described. Products that do not require shelf-stable storage do not require dry ingredients for their preparation and can be made from the indicated ingredients without drying by simply mixing the ingredients, e.g., potatoes, in their natural or cooked state.

The following examples are provided to further illustrate and explain a preferred form of the invention and are not to be taken as limiting in any regard. Unless otherwise indicated, all parts and percentages are by weight.

### EXAMPLE 1

This example illustrates the preparation of a dry mix for preparing a low-carbohydrate potato product according to a preferred aspect of the invention. The following ingredients are prepared according to the process that follows.

| Ingredient | Parts by Weight |
|---|---|
| Potato powder | 22.5 |
| Dried cauliflower | 23.5 |
| Calcium caseinate | 22.2 |
| Dried egg whites | 20.5 |
| Onion powder | 7.0 |
| Sodium chloride | 2.0 |
| Saladizer 250 PH, gums | 1.5 |
| Ground black pepper | 0.8 |

The above ingredients are combined and blended in a V-blender until a uniform dry mix according to the invention is achieved.

### EXAMPLE 2

French Fries are prepared using the dry mix of Example 1, from the following ingredients and procedure:

½ cup Dry Mix of Example 1

¾ cup warm water

Vegetable oil or

or vegetable spray for frying

1. Blend ½ cup mix with ¾ cup water in small bowl.

2. Coat nonstick skillet with vegetable spray or heat 2 tablespoons vegetable oil until hot.

3. Form 4½″-thick patties in skillet with spoon. Cook until lightly browned on both sides.

4. Remove patties from skillet; slice into 32-40 fries. Brown fries on all sides in small amount of additional oil or vegetable spray, or fry in deep fryer in oil heated to 360° F. for 1-2 minutes or until golden brown. Serves 4, approximately 8-10 fries per serving; 6 grams digestible carbohydrates (8 grams total carbohydrates, including fiber).

### EXAMPLE 3

Hash browns are prepared using the dry mix of Example 1, from the following ingredients and procedure:

½ cup Dry Mix of Example 1

¾ cup warm water

1 tablespoon each sautéed minced onion (optional) and sautéed minced green pepper (optional)

Dash salt and black pepper

Vegetable oil or

vegetable cooking spray for frying

1. Blend Dry Mix of Example 1 and water in medium bowl.

2. Stir in onion (optional) and green pepper (optional).

3. Add salt and pepper.

4. Coat bottom of small skillet with vegetable oil or cooking spray and place on medium-high heat.

5. Place mixture in skillet and cook, turning continuously with spatula until lightly browned, around 2-3 minutes.

Serves 4; 6.5 grams digestible carbohydrate per serving (total carbohydrates 8.5 grams, including 2 grams fiber).

### EXAMPLE 4

Corned Beef Hash is prepared using the dry mix of Example 1, from the following ingredients and procedure:

½ cup Dry Mix of Example 1

5 oz. warm water

Vegetable oil

or vegetable spray for frying

4 oz. lean canned corned beef, cubed

1. Blend Dry Mix of Example 1 with water in small bowl, stirring until smooth.

2. Place ¼″ of oil in 10″ non-stick skillet until hot, or coat skillet with vegetable spray and heat on medium-high.

3. Spoon batter into skillet, forming 4½″-deep patties. Cook 2-3 minutes or until golden brown on each side.

4. Remove patties from skillet onto plate. Cut into ½″ fries.

5. Place fries in pan and brown on all sides. Remove from pan and cut into cubes.

6. Return to pan and brown cubes on all sides. Add corned beef and stir together until lightly browned.

Serves 4, approximately ½ cup hash per serving; 8 grams digestible carbohydrates (10 grams total carbohydrates, including 2 grams fiber).

### EXAMPLE 5

Mashed Potatoes are prepared using the dry mix of Example 1, plus the following ingredients and procedure:

½ cup Dry Mix of Example 1

½ cup half-and-half, milk or water

1 tablespoon butter

½ teaspoon salt

Dash black pepper

Blend all ingredients in microwaveable bowl. Microwave on high for 2 minutes; fluffing with fork every 30 seconds. Fluff with fork and return to microwave for 1 minute. Stir again before serving. Serves 4; 6 grams digestible carbohydrates per serving if using water (8 grams total carbohydrates including fiber).

### EXAMPLE 6

Potato Pancakes are prepared using the dry mix of Example 1, from the following ingredients and procedure:

½ cup Dry Mix of Example 1

¾ cup warm water

1 egg yolk

½ medium onion (optional)

Vegetable oil or

vegetable spray for frying

1. Blend water, egg yolk and onion in blender (if using onion, blend until onion is coarsely chopped). Blend in dry mix of Example 1.

2. Place ¼″ vegetable oil in 10″ skillet, or coat bottom of skillet with vegetable spray, and place on medium-high heat.

3. Place heaping tablespoonsful of mixture into skillet and cook 2-3 minutes. When edges bubble, turn over; cook 2-3 minutes until lightly browned. Makes 8 pancakes or 4 servings; 6 grams digestible carbohydrates per serving (8 grams total carbohydrates including 2 grams fiber).

### EXAMPLE 7

### Processing of Low-Carbohydrate Frozen French Fries

1. By weight combine 1 part dry powder mix with 1 part water.

2. Mix well to dough-like consistency.

3. Place dough in single-screw extruder (Brabender D=¾″; L/D=20)

4. Extrude through 0.40-inch square die at 60° C. and 150 rpm.

5. Cut with guillotine or other blade into 3-inch lengths.

6. Par fry at 390° F. for 5-10 seconds.

7. Cool, package and freeze.

8. Customer use: Deep-fry at 360° F. for about 1-2 minutes. OR toss with small amount of oil or coat with vegetable spray and bake at 425° F. for 10-12 minutes.

### EXAMPLE 8

### Alternative Processing of Low-Carbohydrate Frozen French Fries

1. By weight combine 1 part dry powder mix with one part water.

2. Mix well to dough-like consistency.

3. Force dough through sheeter to create ¼ inch sheet of mixture.

4. Roll sheet onto immersible fine mesh bed and cover with fine mesh screen.

5. Seal on all sides and par fry at 390° F. for 8 seconds. OR spray with oil on both sides and par bake.

6. Use grid cutter to cut sheet into ¼-inch×¼-inch″×3-inch fries.

7. Par fry for 3-5 seconds at 390° F.

8. Cool, package and freeze.

Customer use: Deep-fry at 360° F. for 1-2 minutes. OR toss with small amount of oil or coat with vegetable spray and bake at 425° F. for 10-12 minutes.

The above description is intended to enable the person skilled in the art to practice the invention. It is not intended to detail all of the possible modifications and variations, which will become apparent to: the skilled worker upon reading the description. It is intended, however, that all such modifications and variations be included within the scope of the invention which is defined by the following claims. The claims are meant to cover the indicated elements and steps in any arrangement or sequence which is effective to meet the objectives intended for the invention, unless the context specifically indicates the contrary.

1. A dry mix for preparing a low-carbohydrate potato product, comprising:
dried potato and cauliflower, preferably mixed together with a suitable water-dispersible or water-soluble binder.

2. Preparing the mix of claim 1 for serving by mixing with water to provide a suitable consistency for final preparation, e.g., by simply heating or frying or baking.

3. A process for preparing a low-carbohydrate potato product, comprising: mixing dried potato and dried cauliflower, together with a suitable water-dispersible or water-soluble binder, with an aqueous liquid in an amount sufficient to fully hydrate the dried potato, cauliflower and any binder or water-soluble ingredients to provide a suitable consistency for final preparation; and finally preparing the resulting mixture, e.g., by cooking.

4. Potato products, prepared from the dry mix and the above process.

5. Potato products are prepared from the mix of claim 1, without drying by simply mixing the ingredients, including potatoes and cauliflower, in their natural or cooked state.

6. A process for preparing a low-carbohydrate potato product utilizing the mix of claim 1, comprising:
hydrating the mix;
extruding the hydrated mix;
cutting the extruded mix into strips of suitable size for frying as French fries.
